(19) United States
(12) Patent Application Publication
(10) Pub. No.: US 2026/0360156 A1
(43) Pub. Date: Nov. 12, 2026

(54) USING HIERARCHICAL GAUSSIAN PRIMITIVES WHEN DETERMINING OBJECT OCCUPANCY

(71) Applicant: QUALCOMM Incorporated, San Diego, CA (US)

(72) Inventors: Yunxiao Shi, San Diego, CA (US); Yinhao Zhu, La Jolla, CA (US); Hong Cai, San Diego, CA (US); Jisoo Jeong, San Diego, CA (US); Shizhong Steve Han, San Diego, CA (US); Amin Ansari, Kent, WA (US); Fatih Murat Porikli, San Diego, CA (US)

(21) Appl. No.: 19/287,598

(22) Filed: Jul. 31, 2025

Related U.S. Application Data
(60) Provisional application No. 63/803,133, filed on May 9, 2025.

(51) Int. Cl. G06V 20/58; G06T 17/00; G06V 10/25; G06V 20/70

(52) U.S. Cl. CPC G06V 20/58; G06T 17/00; G06V 10/25; G06V 20/70; G06V 2201/07

(57) ABSTRACT

An example device for generating a representation of objects through processing of media data, such as image data, includes a processing system configured to apply hierarchically arranged Gaussian primitives to the one or more images to obtain a representation of the three-dimensional space around the vehicle, apply one or more static queries and one or more dynamic queries to the representation of the three-dimensional space around the vehicle to identify one or more static objects and one or more dynamic objects within the representation of the three-dimensional space around the vehicle, and output an indication of the one or more static objects and the one or more dynamic objects.

This application claims the benefit of U.S. Provisional Application No. 63/803,133, filed May 9, 2025, the entire contents of which is hereby incorporated by reference.

### TECHNICAL FIELD

This disclosure relates to computer vision systems, such as assisted driving systems.

### BACKGROUND

Techniques are being researched and developed related to advanced driving assistance systems. For example, artificial intelligence and machine learning (AI/ML) systems are being developed and trained to determine how best to operate a vehicle according to applicable traffic laws, safety guidelines, external objects, roads, and the like. Using cameras to collect images of a scene, the AI/ML system may determine object occupancy within the scene and the AI/ML system may query a processed version of the images, where the query may represent a feature vector. Typically, queries are defined for both static and dynamic objects within the scene.

The AI/ML system may perform three dimensional (3D) occupancy prediction, which jointly estimates the occupancy state and semantic label of each voxel in the scene from the images. Generally, each voxel has an occupancy state of occupied, free, or unobserved. The AI/ML system may assign semantic labels to each occupied voxel and out-of-vocabulary objects are labels as general objects (which are typically undetected by 3D object detection but may be critical for safety).

Scene representation may cause problems in 3D occupancy detection (and 3D perception in general), which may have a large impact on accuracy and runtime efficiency. Existing attempts at scene representation may fall into two categories. A first category may involve dense voxel grids that entail large memory footprints and result in inefficient processing. Attempts to reduce the memory footprint via bird-eye-views (BEV) or tri-plane views (TPV) may result in lost 3D information. A second category involves sparse queries that regress point locations and class scores, but may require a large number of points to represent big objects (e.g., a road, a truck, etc.). In this second category, the AI/ML system may employ a single set of queries to predict 3D occupancy, which may result in difficulties in distinguishing between static and dynamic objects in the scene.

More recently, attempts have been made to extend points to Gaussian primitives. However, these attempts may either require voxelization or can only use a small number of Gaussian primitives. Injecting voxelization into these systems may result in large memory footprints as noted above, while a small number of Gaussians primitives may result in limited modeling capabilities.

### SUMMARY

In general, this disclosure describes techniques for determining positions of objects in a real-world environment using a hierarchical Gaussian approach that utilizes two separate classes of queries (e.g., static queries and dynamic queries). Use of a hierarchical Gaussian may allow for more complete modeling of the scene that is adapted for the two separate classes of queries. An AI/ML system may be separately trained to accommodate the two distinct classes of queries, which may represent feature vectors defined in the Gaussian space that the AI/ML system may initialize and apply to possibly more accurately predict 3D occupancy. By separating the queries into two distinct classes, the AI/ML system may focus on dynamic objects (e.g., a moving car, a moving truck, a pedestrian, a bicycle, etc.), predicting a velocity for each dynamic object in the scene and effectively reducing processing requirements for static objects within the scene (e.g., a building, a tree, a parked car, etc.).

In one example, the techniques are directed to a method of processing image data, the method comprising: obtaining, from a multi-camera system of a vehicle, one or more images of a three-dimensional space around the vehicle; applying hierarchically arranged Gaussian primitives to the one or more images to obtain a representation of the three-dimensional space around the vehicle; applying one or more static queries and one or more dynamic queries to the representation of the three-dimensional space around the vehicle to identify one or more static objects and one or more dynamic objects within the representation of the three-dimensional space around the vehicle; and outputting an indication of the one or more static objects and the one or more dynamic objects.

In another example, the techniques are directed to a device for processing image data, the device comprising: a memory for storing one or more images of a three-dimensional space around a vehicle; and a processing system comprising one or more processors implemented in circuitry, the processing system being configured to: apply hierarchically arranged Gaussian primitives to the one or more images to obtain a representation of the three-dimensional space around the vehicle; apply one or more static queries and one or more dynamic queries to the representation of the three-dimensional space around the vehicle to identify one or more static objects and one or more dynamic objects within the representation of the three-dimensional space around the vehicle; and output an indication of the one or more static objects and the one or more dynamic objects.

In another example, the techniques are directed to a device for processing media data, the device comprising: means for obtaining, from a multi-camera system of a vehicle, one or more images of a three-dimensional space around the vehicle; means for applying hierarchically arranged Gaussian primitives to the one or more images to obtain a representation of the three-dimensional space around the vehicle; means for applying one or more static queries and one or more dynamic queries to the representation of the three-dimensional space around the vehicle to identify one or more static objects and one or more dynamic objects within the representation of the three-dimensional space around the vehicle; and means for outputting an indication of the one or more static objects and the one or more dynamic objects.

In another example, the techniques are directed to a computer program product that includes non-transitory computer-readable storage media storing instructions that, when executed, causes processing circuitry to: apply hierarchically arranged Gaussian primitives to one or more images and obtain a representation of a three-dimensional space around a vehicle; apply one or more static queries and one or more dynamic queries to the representation of the three-dimensional space around the vehicle to identify one or more static objects and one or more dynamic objects within the representation of the three-dimensional space around the vehicle; and output an indication of the one or more static objects and the one or more dynamic objects.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example vehicle including an autonomous driving controller according to techniques of this disclosure.

FIG. 2 is a block diagram illustrating an example set of components of an autonomous driving controller according to techniques of this disclosure.

FIG. 3 is a block diagram illustrating an example set of components that may be included in the object analysis unit of FIG. 2 according to techniques of this disclosure.

FIG. 4 is a block diagram illustrating an example vehicle with a multi-camera system and an autonomous driving controller according to techniques of this disclosure.

FIG. 5 is a table illustrating an example of results achieved by the object analysis unit of FIG. 2 according to various aspects of techniques described in this disclosure.

FIG. 6 is a flowchart illustrating example operation of an autonomous driving controller 120 shown in the example of FIG. 1 in performing the techniques described in this disclosure.

### DETAILED DESCRIPTION

Three-dimensional object detection (3DOD) may include generating a representation of a three-dimensional space. That is, while cameras may capture images to the sides of a moving object, such as a vehicle, and a LIDAR unit or other point cloud producing unit(s) (possibly involving point clouds processed by stereo cameras) may capture a point cloud representation (which may refer to a ground truth three dimensional point cloud), the camera and point cloud data may be used to generate a three dimensional representation of an area around the moving object. Downstream tasks, such as object tracking and prediction (including occupancy detection), may benefit from this three dimensional representation.

Artificial intelligence and machine learning (AI/ML) systems are being developed and trained to determine how best to operate a vehicle according to applicable traffic laws, safety guidelines, external objects, roads, and the like. Using cameras to collect images of a scene, the AI/ML system may determine object occupancy within the scene and the AI/ML system may query a processed version of the images, where the query may represent a feature vector. Typically, queries are defined for both static and dynamic objects within the scene.

The AI/ML system may perform three dimensional (3D) occupancy prediction, which jointly estimates the occupancy state and semantic label of each voxel in the scene from the images. Generally, each voxel has an occupancy state of occupied, free, or unobserved. The AI/ML system may assign semantic labels to each occupied voxel and out-of-vocabulary objects are labeled as general objects (which are typically undetected by 3D object detection but may be critical for safety).

Scene representation may cause problems in 3D occupancy detection (and 3D perception in general), which may have a large impact on accuracy and runtime efficiency. Existing attempts at scene representation may fall into two categories. A first category may involve dense voxel grids that entail large memory footprints and result in inefficient processing. Attempts to reduce the memory footprint via bird-eye-views (BEV) or tri-plane views (TPV) may result in lost 3D information. A second category involves sparse queries that regress point locations and class scores, but may require a large number of points to represent big objects (e.g., a road, a truck, etc.). In this second category, the AI/ML system may employ a single set of queries to predict 3D occupancy, which may result in difficulties in distinguishing between static and dynamic objects in the scene.

More recently, attempts have been made to extend points to Gaussians. However, these attempts may either require voxelization or can only use a small number of Gaussian primitives. Injecting voxelization into these systems may result in large memory footprints as noted above, while a small number of Gaussians may result in limited modeling capabilities.

This disclosure describes techniques that use hierarchically arranged Gaussian primitives for purposes of three dimensional occupancy prediction. In particular, Gaussian primitives may be calculated based on sensor input, such as from features extracted from image and point cloud data. The features may be fused to form an initial representation of the three-dimensional space. The use of Gaussian primitives may address uncertainty and missing data while maintaining computational efficiency. Gaussian splatting is a process of projecting Gaussian primitives onto a 2D or into a 3D space by “splatting” their probabilistic distributions, enabling smooth, continuous scene representation and interpolation across sparse or missing data regions.

The techniques of this disclosure include introduction of Gaussian primitives into the fusion pipeline, which may offer a robust solution to the challenges of missing views, uncertainty, and noise in camera-fusion. The use of Gaussian primitives per the techniques of this disclosure may provide a more effective approach than conventional techniques, particularly as applied in the context of three dimensional occupancy detection.

In general, generating a representation of a space from fusion of features based on sensor input is hindered by uncertainty that arises from the sensor input (e.g., image data) due to sensor noise, occlusions, or incomplete views. Gaussian primitives, which correspond to features representative of objects in a three-dimensional space, naturally capture the uncertainty by explicitly modeling spatial variance. Each Gaussian primitive may be parameterized by a mean value and a covariance, such as a covariance matrix. The mean value (μ) represents a central position of an object or feature in the space. The covariance, e.g., covariance matrix, acts as a direct representation of the uncertainty or spread around the mean. This covariance (matrix) allows for a continuous, probabilistic representation of objects and scene elements in the space, which allows a generation system to handle noisy or incomplete sensor data more gracefully. Unlike deterministic representations that assume perfect accuracy, Gaussian primitives can handle uncertain depth estimates from camera sensors by quantifying the confidence in the detected features.

Gaussian primitives offer a smooth, continuous representation of objects and features in the representation of the three-dimensional space. This contrasts with the discrete point-based representations often used in point cloud systems or the grid-based features from camera images. The Gaussian representation may offer a variety of benefits. Use of Gaussian primitives may interpolate missing data. When certain regions in the space have missing sensor data (e.g., due to occlusions or sensor limitations), Gaussian primitives can smooth over these regions, providing estimates based on the spread of surrounding data. This may help to fill gaps caused by missing views in camera inputs. Additionally, the Gaussian primitives may handle noisy data. Gaussian primitives are naturally suited for handling noisy data by representing uncertainty as a spread around the mean, thus preventing overconfident predictions in uncertain regions.

Gaussian primitives can provide a compact way to represent spatial information, reducing the overall complexity of the model. Instead of maintaining dense feature maps or point clouds that require substantial computation, Gaussian primitives reduce the burden by representing features probabilistically through a small set of parameters (e.g., mean and covariance). The compact nature of Gaussian primitives may improve the computational efficiency of the three-dimensional occupancy prediction process, which is crucial for real-time applications in, e.g., autonomous driving. Gaussian primitives can represent complex, large-scale environments without the need for dense input data. This may offer a significant advantage over competing techniques, which require dense data for accurate reconstruction and struggle with scalability.

Gaussian primitives can act as guiding anchors during the fusion of camera features. By representing the spatial uncertainty and position of objects or scene elements probabilistically, Gaussian primitives can enhance attention mechanisms that align and merge camera, point cloud data, and/or other multi-sensor input data. Gaussian primitives may encode depth and shape information, which can improve the precision of object boundaries and depths in the fused representation. In regions with missing or incomplete views, Gaussian primitives can act as object localization, guiding the fusion process to make more informed decisions based on uncertainty-aware representations.

Gaussian primitives may offer real-time inference and robustness to noisy data. Gaussian primitives are computationally efficient to predict and can be integrated into real-time systems. The probabilistic nature of Gaussian primitives allows them to handle sparse and noisy sensor inputs more effectively than competing models, making Gaussian primitives a better fit for fusion in dynamic environments.

Further, these Gaussian primitives may include additional information, such as semantics that identify a type or label for each object. The Gaussian primitives may refer to an atomic element in the three-dimensional scene representation, where each element has a feature vector that can be decoded into three dimensional Gaussian splatter (GS) parameters, such as a three dimensional mean, co-variance, three dimensional position, spherical harmonics, and transparency (e.g., whatever is required to perform rendering/splattering), as well as potentially other information such as semantic class. Each primitive has a co-variance (as noted above), which indicates how much space this primitive influences during the rendering process. For instance, when a ray is shot from a 2D pixel into 3D space during rendering, a Gaussian primitive contributes to this pixel value if this ray intersects with the space covered by its covariance.

In addition, the hierarchically arranged Gaussian primitives may enable feature extraction that are separately categorized via two distinct classes of queries. That is, rather than provide a single query for both static objects and dynamic objects, the hierarchical Gaussian model may accept two distinct queries related to static objects and dynamic objects within the representation of the three dimensional model. By separating the queries in this manner, the hierarchical Gaussian model may reduce computational complexity, electing to spend more compute power on dynamic objects (in terms of identifying a velocity, a bounding box, etc.) representative of the dynamic objects while reducing possible compute requirements for tracking static objects. In this sense, various aspects of the techniques may not only accommodate lost or noisy sensor data but may improve the model while also reducing compute requirements in comparison to competing models that rely on dense point clouds, voxelization, etc.

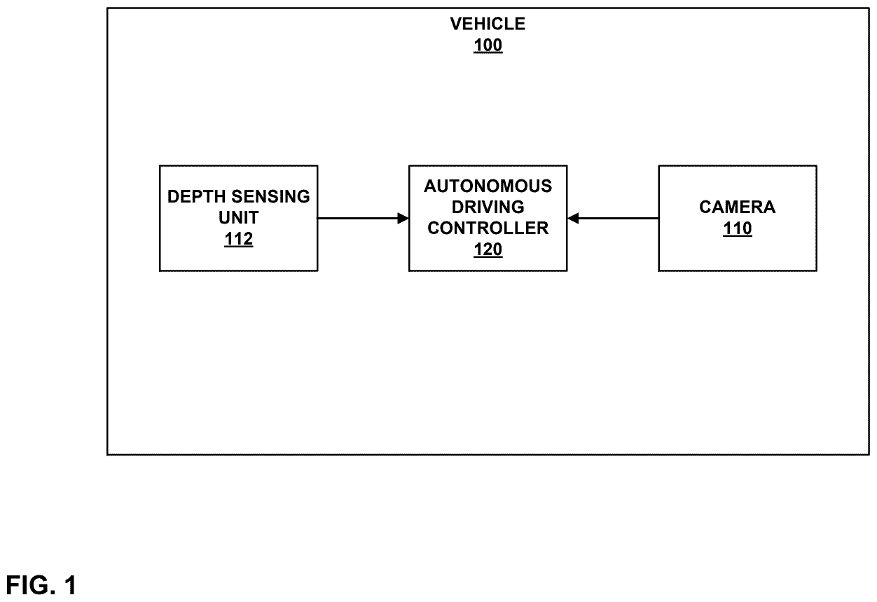

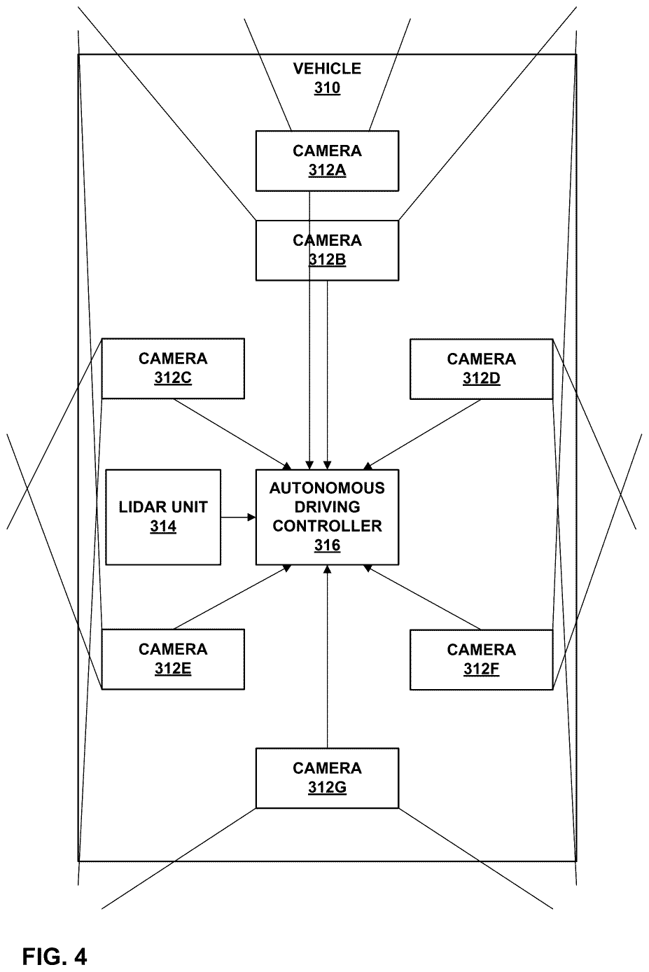

FIG. 1 is a block diagram illustrating an example vehicle 100 including an autonomous driving controller 120 according to techniques of this disclosure. In this example, vehicle 100 includes a camera 110, a depth sensing unit 112, and an autonomous driving controller 120. The Camera 110 is a single camera in this example. While only a single camera is shown in the example of FIG. 1, in other examples, multiple cameras may be used. However, the techniques of this disclosure allow for depth to be calculated for objects in images captured by the camera 110 without additional cameras. In some examples, multiple cameras may be employed that face different directions, e.g., front, back, and to each side of the vehicle 100, e.g., as shown in FIG. 4. The autonomous driving controller 120 may be configured to calculate depth for objects captured by each of such cameras.

The depth sensing unit 112 may include any or all of a light detection and ranging (LIDAR) unit, a radio detection and ranging (RADAR) unit, a depth from stereo unit, and/or other devices that calculate depth values for objects in a real-world environment. The depth sensing unit 112 provides point cloud data (e.g., LIDAR data) for the vehicle 100 to the autonomous driving controller 120. The depth sensing unit 112 may, for example, determine a point cloud for a three-dimensional area, where the camera 110 also captures an image of the area. In the case of LIDAR, for example, the point cloud may generally include points corresponding to surfaces or objects in the area identified by a light (e.g., laser) emitted by the depth sensing unit 112 and reflected back to the depth sensing unit 112. Based on the angle of emission of the light from the depth sensing unit 112 and time taken for the light to traverse from the depth sensing unit 112 to the object and back, the depth sensing unit 112 can determine a three-dimensional coordinate for the point.

The autonomous driving controller 120 receives image frames captured by the camera 110, e.g., at a high frame rate, such as 30 fps, 60 fps, 90 fps, 120 fps, or even higher. The autonomous driving controller 120 may also receive point cloud data captured by the depth sensing unit 112, e.g., at a corresponding rate, such that a point cloud is paired with the image frame (or frames of a multi-camera system). The autonomous driving controller 120 may include an (artificial) neural network, such as a feed forward network (FFN), trained according to the techniques of this disclosure to predict three-dimensional occupancy extracted from the frame(s) and/or the point cloud data.

According to the techniques of this disclosure, the autonomous driving controller 120 may receive a point cloud or other such data structure from the depth sensing unit 112 and/or image data from the camera 110 (at a given time). The autonomous driving controller 120 may extract features from the point cloud (which may also be considered a type of range data) and the camera image data, form respective projections using the extracted features, and fuse the projections to form an initial representation of the three-dimensional space around vehicle 100. The autonomous driving controller 120 may then generate Gaussian primitives from the point cloud data 152 and/or the image data 150 and merge the initial representation with the Gaussian primitives, e.g., using Gaussian splatting (GS), to form an enhanced representation.

The use of Gaussian primitives introduces a probabilistic representation of spatial features in the space, explicitly modeling uncertainty with a covariance (matrix) for each feature. This may enhance robustness to noise, occlusion, and missing data, improving the reliability of object detection and scene understanding. Unlike static representations, the Gaussian primitives can dynamically deform based on local scene complexity. For uncertain regions (e.g., occlusions or motion), the covariance elongates to capture uncertainty, while in stable regions, the covariance contracts for finer detail. This adaptive modeling offers a context-sensitive approach to uncertainty.

Gaussian primitives may provide a smooth and continuous interpolation of sparse or incomplete sensor data. This may mitigate the limitations of fusion methods that struggle with sensor dropouts or sparse input data, enhancing the completeness of view reconstructions. The integration of Gaussian primitive priors into the self-attention mechanism can improve feature selection during the decoding process. By modulating the contribution of uncertain regions, the network's attention is more focused on reliable features, leading to better object localization and prediction accuracy.

The gaussian primitives offer a compact yet expressive form of spatial features, reducing the overall computational load of computing a representation of the three dimensional space around the vehicle 100. This makes the system more scalable for large outdoor environments and suitable for real-time applications like autonomous driving, where both speed and accuracy are crucial. By applying the Gaussian primitives in a hierarchical manner (e.g., from coarse to fine), the final, enhanced feature map may achieve better interpolation of missing data and more accurate spatial distributions, leading to potentially improved performance in downstream tasks like tracking, motion forecasting, object detection, three dimensional occupancy detection, etc.

In operation, the autonomous driving controller 120 may obtain one or images from the camera 110 of a space surrounding the vehicle 100 (which may be referred to as a scene). The autonomous driving controller 120 may apply an image encoder to obtain multi-scale features, which are then processed in the form of one or more static queries and one or more dynamic queries along with a Gaussian primitive. Static queries attempt to identify static objects within the scene, while dynamic queries attempt to identify dynamic (or, in other words, moving) objects within the scene.

The autonomous driving controller 120 may initialize the one or more static queries and the one or more dynamic queries along with three dimensional (3D) Gaussian primitives. The autonomous driving controller 120 may then perform multiple layers of point decoding, where each layer may include a feature sampling, self-attention within each layer and/or cross-attention between layers, and a feed forward network (FFN). Each layer outputs a successively finer representation of the scene, resulting a hierarchically arranged set of Gaussian primitives that approximate the scene in more detail, creating what may be referred to as a Gaussian space. The one or more static queries and the one or more dynamic queries also reside in this Gaussian space, allowing the autonomous driving controller 120 to identify one or more static objects (e.g., a building, a road, parked cars, etc.) and one or more dynamic objects (e.g., a pedestrian, a moving vehicle, a bicycle, etc.). The autonomous driving controller 120 may output an indication of the one or more static objects and the one or dynamic objects for further processing, such as decision making in terms of assisting driver control of the vehicle 100 or autonomously enabling control of the vehicle 100.

As noted above, the autonomous driving controller 120 may apply the hierarchically arranged Gaussian primitives in order to identify the one or more static objects and the one or more dynamic objects within the scene. The autonomous driving controller 120 may therefore not require dense grids of voxels that entail a large memory footprint that leads to inefficient processing (e.g., three-dimensional convolutions). While application of processes involving creation of a bird's eye view (BEV) and/or a tri-plane view (TPV) may alleviate some of the memory and processing requirements, BEV and/or TPV may not allow for recovery of lost three-dimensional information. BEV and/or TPV may require equal resource allocation and may not fully differentiate object scale (leading to space modeling followed by classification).

A competing process has since been developed that removes the need for dense grids, BEV and/or TPV, in which point locations are regressed and class scores may be concurrently determined (e.g., predicted by corresponding sparse queries). Yet, this competing process may still require a large number of points to represent big objects (e.g., road, trucks, etc.). The sparse queries may suffer by failing to differentiate between static background and dynamic objects. Application of Gaussians previously in which points are extended to Gaussians either require voxelization or can only use a small number of Gaussians (which may limit modeling capability).

According to various aspects of the techniques described in this disclosure, the autonomous driving controller 120 may separate static queries from dynamic queries, providing separate interfaces for both static queries and dynamic queries (although in some cases, the static queries and dynamic queries may be merged into a single joint query, as described in more detail below). The static and dynamic queries may facilitate modeling of the scene, and may provide effective interaction through cross-attention, enabling the autonomous driving controller 120 to capture complex scene dynamics. Further, application of each hierarchically arranged Gaussian primitive occurs from coarse-to-fine where the autonomous driving controller 120 may inject pixel-level alignment to complement three dimensional occupancy learning.

The static and dynamic queries may either be a query or a key-value pair. In some instances, the dynamic query acts as the query, while the static query may serve as a key value pair. In other instances, the static query acts at the query, and the dynamic query serves as a key value pair. The autonomous driving controller 120 may perform bi-directional cross-attention (effectively forming both of the foregoing) and/or perform aggregated self-attention that may effectively combine dynamic queries and static queries and apply self-attention to the combined queries.

Cross-attention refers to a process in which the autonomous driving controller 120 uses coarse-level attention as the query and the fine-level feature map serves as the key and value. Cross-attention attempts to calculate how much focus each coarse-level region should receive from each fine-level feature, allowing the autonomous driving controller 120 to prioritize certain objects detected at the coarse level and refine their boundaries in the fine map. Self-attention refers to a process in which a Gaussian coarse-to-fine approach includes using self-attention mechanisms to progressively refine feature representations from coarse to fine resolution, which may enhance the model's ability to focus on relevant features across multiple scales. Self-attention may improve accuracy in tasks like object detection, semantic segmentation, and/or trajectory prediction.

Separating the dynamic queries from static queries may allow the autonomous driving controller 120 to focus computational resources on dynamic objects instead of general queries in which all aspects of the scene receive the same computational resources. Further, using hierarchically arranged Gaussians primitives with one or both of cross-attention or self-attention provides a more robust analysis of the scene (including adapting to missing or partial image and/or point data). The autonomous driving controller 120 may then expend less computational resources (e.g., processing power, memory space, etc.) on static objects while expending more computational resources on dynamic objects that may move rapidly and largely constitute the bigger safety hazard for which the autonomous driving controller 120 may be required to monitor more closely relative to static objects (e.g., background stationary objects).

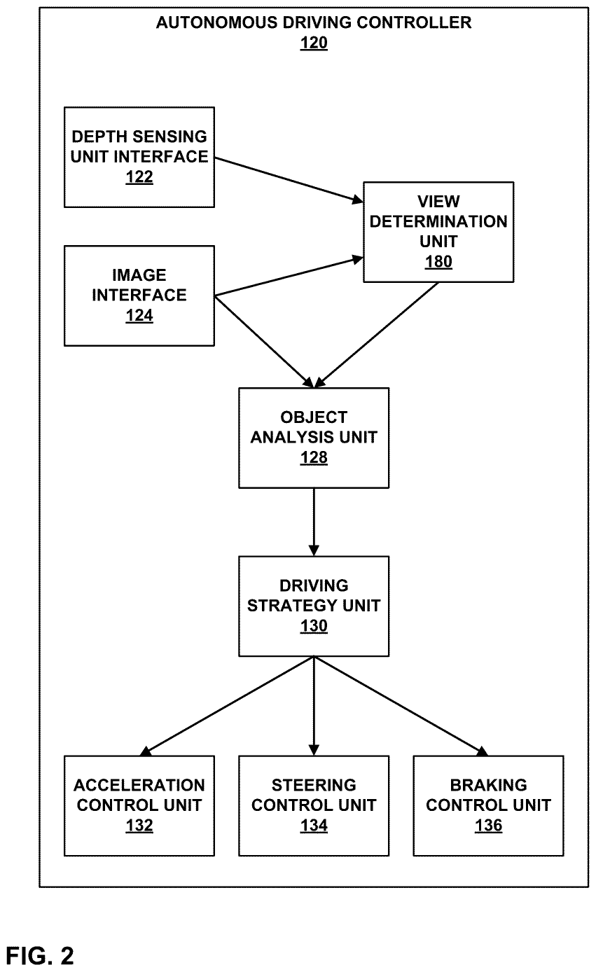

FIG. 2 is a block diagram illustrating an example set of components of autonomous driving controller 120 of FIG. 1 according to techniques of this disclosure. In this example, autonomous driving controller 120 includes depth sensing unit interface 122, image interface 124, view determination unit 180, object analysis unit 128, driving strategy unit 130, acceleration control unit 132, steering control unit 134, and braking control unit 136.

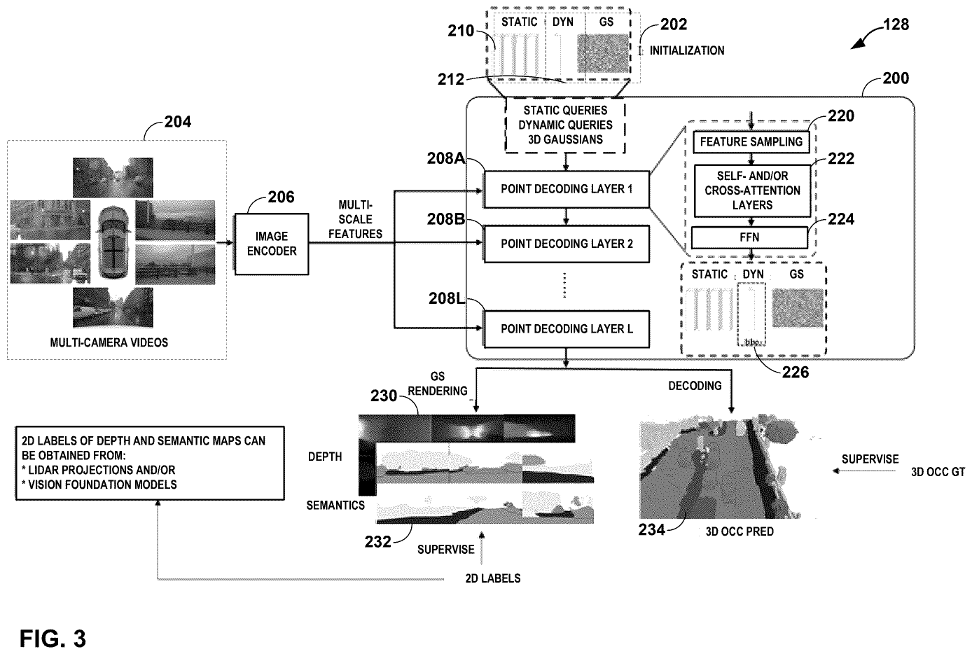

In general, the depth sensing unit interface 122 represents an interface to the depth sensing unit 112 of FIG. 1, which receives point cloud data (e.g., LIDAR data) from the depth sensing unit 112 and provides the LIDAR/point cloud data to view determination unit 180. In particular, as described in greater detail below with respect to FIG. 3, view determination unit 180 may determine a view representation from images received via the image interface 124 and/or a point cloud received via the depth sensing unit interface 122. Per the techniques of this disclosure, view determination unit 180 may extract features from the images and possibly the point cloud, form projection representations using the features, then merge the projections to form a fused initial view representation. Furthermore, the view determination unit 180 may generate Gaussian primitives from the image and/or point cloud (e.g., LIDAR) features, then combine the initial view representation with the Gaussian primitives, e.g., using Gaussian splatting.

The image interface 124 may also provide the image frames to the object analysis unit 128. Likewise, the view determination unit 180 may provide depth values for objects in the images to the object analysis unit 128. The object analysis unit 128 may generally determine where objects are relative to the position of the vehicle 100 at a given time, and may also determine whether the objects are stationary or moving. The object analysis unit 128 may provide object data to the driving strategy unit 130, which may determine a driving strategy based on the object data. For example, the driving strategy unit 130 may determine whether to accelerate, brake, and/or turn the vehicle 100. The driving strategy unit 130 may execute the determined strategy by delivering vehicle control signals to various driving systems (acceleration, braking, and/or steering) via the acceleration control unit 132, the steering control unit 134, and the braking control unit 136.

The various components of autonomous driving controller 120 may be implemented as any of a variety of suitable circuitry components, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure.

FIG. 3 is a block diagram illustrating an example set of components that may be included in the object analysis unit 128 of FIG. 2. In this example, the object analysis unit 128 includes an encoder/decoder network 200 that includes hierarchically arranged Gaussian primitives (Gaussian splattering-GS-kernels) 202 according to various aspects of the techniques described in this disclosure. The Gaussians primitives 202 may form a Gaussian network and may be referred to as Gaussian network 202. The object analysis unit 128 may receive the images 204 via the camera(s) 110 (shown in the example of FIG. 1) in the form of image data and/or video data (e.g., from one or more of the cameras(s) 110, such as cameras in front, to the sides of, and/or to the rear of the vehicle 100 of FIG. 1).

The object analysis unit 128 may include an image encoder 206 that encodes images 204 as multi-scale feature vectors that identify key points within images 204. The object analysis unit 128 may include multiple point decoding layers 1-L (shown as a cursive small capitalized “l” in the example of FIG. 3). The point decoding layers 1-L may be denoted as point decoding layers 208A-208L (“the point decoding layers 208”). Each of the point decoding layers 208 may separately apply feature sampling 220 (at the different scales from coarse to fine), passing these features between each successive one of point decoding layers 208 to refine the representation of the features, and apply self-attention and cross-attention 222 along with a feed forward network 224 (“FFN 224”).

The point decoding layers 208 may individually refine the approximation of objects from coarse to fine details. Each of the point decoding layers 208 may perform the feature sampling 220 in order to identify features within the encoded version of the images 204 that potentially satisfy or otherwise correspond to one or more of the static queries 210 and/or the one or more dynamic queries 212. Every static query 210 and dynamic query 212 (a pillar in the example shown in FIG. 3) includes a 3D Gaussian primitive (so the parameters can be decoded from its feature vector). In this way, Gaussian splatting can be performed from the 3D queries (left branch at bottom near 230). At the same time, these static queries 210 and dynamic queries 212 can be decoded into 3D semantic occupancy (right branch at bottom near 234).

In some examples, the set of static queries 210 and dynamic queries 212 can be decoded from any decoding stage, decode their 3DGS parameters, and perform splatting to create 2D images. Additional extensions are possible in which a Bezier triangle is applied along with the Gaussian primitives, which may provide sharper details. In FIG. 3, only using the final queries from the last stage is shown, but this can be done using queries from any stage (e.g., these queries can be thought of as 3D points with features that are refined through the point decoding layers 208). Using the identified features, each of the point decoding layers 208 may apply self-attention and/or cross-attention layers to refine attention between each of the point decoding layers 208 within itself and between different ones of the point decoding layers 208.

The object analysis unit 128 may initialize the static queries 210, the dynamic queries 212, and Gaussian splattering (GS) kernel 202 used to render a depth map 230, and a semantic map 232. The final point decoding layer 208L (or a different rendering unit, which is not shown in the example of FIG. 3) may perform the rendering while also decoding a representation of a three-dimensional occupancy prediction 234. The object analysis unit 128 may supervise the depth map 230, the semantic map 232, and the three dimensional occupancy prediction 234. The object analysis unit 128 may supervise the depth map 230 and/or the semantic map 232 through application of two dimensional labels of depth and semantic maps obtained, to provide a couple of examples, LiDAR projections and/or vision foundation models. The object analysis unit 128 may also supervise the three-dimensional occupancy prediction 234 using a three-dimensional occupancy ground truth (e.g., using LiDAR point clouds, stereo camera point clouds, etc.).

For the dynamic queries 212, the object analysis unit 128 may apply the point decoding layers 208 in order to approximate a velocity of the corresponding dynamic object present in the scene represented by the depth map 230, the semantic map 232, and/or the three-dimensional occupancy prediction 234. The object analysis unit 128 may apply the feed forward network 224 using the dynamic queries 212 as inputs, which attempts to approximate the velocity for each identified dynamic object within the scene. In some instances, the object analysis unit 128 may determine a camera exposure time of the camera(s) 110 to approximate the velocity. The learned velocity may provide a positional offset when using the dynamic query's 212 current three-dimensional location to sample perspective view features from a camera frame off a different time step. Rather than only account for the velocity of the vehicle 100 when performing such sampling, the object analysis unit 128 may account for a dynamic object's own velocity in order to sample the correct corresponding position on a two-dimensional camera frame.

Also for the dynamic queries 212, the object analysis unit 128 may predict a bounding box (“bbox”) 226 and the class score from each dynamic query and supervised by bounding box supervisors. By extracting the subset of points from the ground truth three-dimensional point cloud that represent the dynamic (or, in other words, moving) objects, the object analysis unit 128 may directly provide point-level supervision to the dynamic queries 212 in terms of both three dimensional positions and semantic classes. The object analysis unit 128 may also densify (e.g., using learned layers) the prediction of dynamic queries 212 and supervise the densified version of predicted three-dimensional points using the subset of dynamic ground truth points. After combining the static queries 210 and the dynamic queries 212 (or the densified points derived therefrom), the object analysis unit 128 may supervise the total set using the full grand truth three-dimensional point cloud or occupancy.

Following coarse-to-fine densification of points across N (which may be set to six) the point decoding layers 208, each of the point decoding layers 208 predicts R_i Gaussians per query, where R_i<R_{i+1} for i=1, . . . , N−1. For each of the point decoding layers 208, the object analysis unit 128 may render the depth map 230 and the semantic map 232 from the predicted Gaussians to all input cameras 110 (including previous times), and then supervises with corresponding LiDAR/pseudo-depth and/or LiDAR/pseudo semantic maps. The object analysis unit 128 may perform motion compensation for dynamic Gaussians before rendering to the cameras 110 in previous time step, e.g., a velocity is associated with each Gaussian and we displace the dynamic objects three-dimensional position.

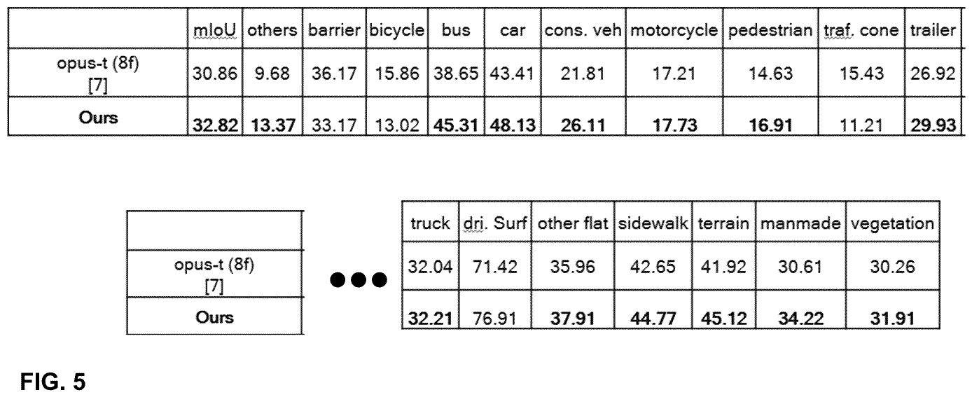

The object analysis unit 128 may effectively predict static Gaussians from the static queries 210, and bounding boxes and dynamic Gaussians from the dynamic queries 212, potentially applying supervision by corresponding occupancy and detection ground truth. The object analysis unit 128 may apply self-attention and/or cross-attention 222 on a set of concatenated static and dynamic queries 210/212. The object analysis unit 128 may, as noted above, impose supervision of the depth map 230 and the semantic map 232. The foregoing process performed by the object analysis unit 128 may improve an average mean Intersection of Union (mIoU) as shown in the table presented in FIG. 5, increasing the mIoU for different classes, such as classes denoted as “bus,” “car,” “construction vehicle,” “trailer,” and “truck,” which are dynamic traffic agents in the scene. The higher mIoU denotes a better result compared to the previous analysis of competing systems (e.g., Opus-t-8f).

In this respect, various aspects of the techniques may enable the object analysis unit 128 to predict scene Gaussians using the static queries 210 and the dynamic queries 212 and compensate for object motion for dynamic query predictions. The object analysis unit 128 may also provide effective interaction between the static queries 210 and the dynamic queries 212 through cross-attention. Using the hierarchically arranged Gaussian primitives, the object analysis unit 128 may allow for a much larger number of Gaussians that may result in better modeling capabilities. Further, the object analysis unit 128 may perform multi-stage rendering supervision, which may inject pixel-level alignment to complement three dimensional occupancy learning (e.g., enabled through weakly-supervised learning).

The object analysis unit 128 that implements various aspects of the techniques described in this disclosure may provide three-dimensional geometric and semantic understanding of the traffic scene beyond three dimensional bounding boxes. The object analysis unit 128 may capture obstacles that do not belong to the defined set of classes while also providing input into the driving strategy unit 130.

FIG. 4 is a block diagram illustrating an example vehicle 310 with a multi-camera system and autonomous driving controller 316 according to techniques of this disclosure. In particular, the vehicle 310 includes cameras 312A-312G, and a LIDAR unit 314. In this example, the cameras 312A and 312B are front-facing cameras with different focal lengths, the cameras 312C and 312D are side-rear facing cameras, cameras 312E and 312F are side-front facing cameras, and the camera 312G is a rear-facing camera. In this manner, imagery can be captured by the collection/set of cameras 312A-312G for a 360 degree view around the vehicle 310.

The LiDAR unit 314 may generate LiDAR/point cloud data around vehicle 310 in 360 degrees. Thus, the LiDAR/point cloud data may be generated for images captured by each of the cameras 312A-312G. Both images and LIDAR data may be provided to the autonomous driving controller 316.

The autonomous driving controller 316 may include components similar to those of the autonomous driving controller 120 of FIG. 2. For example, the autonomous driving controller 316 may include an object analysis unit that performs the techniques of this disclosure, as discussed above, to extract features from the images and (possibly) LiDAR data, fuse the extracted features, then generate a depth map from the fused features. In particular, the autonomous driving controller 316 may track features extracted from images and possibly LiDAR data over time, e.g., from consecutive frames, according to the techniques of this disclosure, to identify static objects and dynamic objects of a real-world space around the vehicle 310. The autonomous driving controller 316 may then use the indication of static objects and dynamic objects when making autonomous driving decisions to control the vehicle 310.

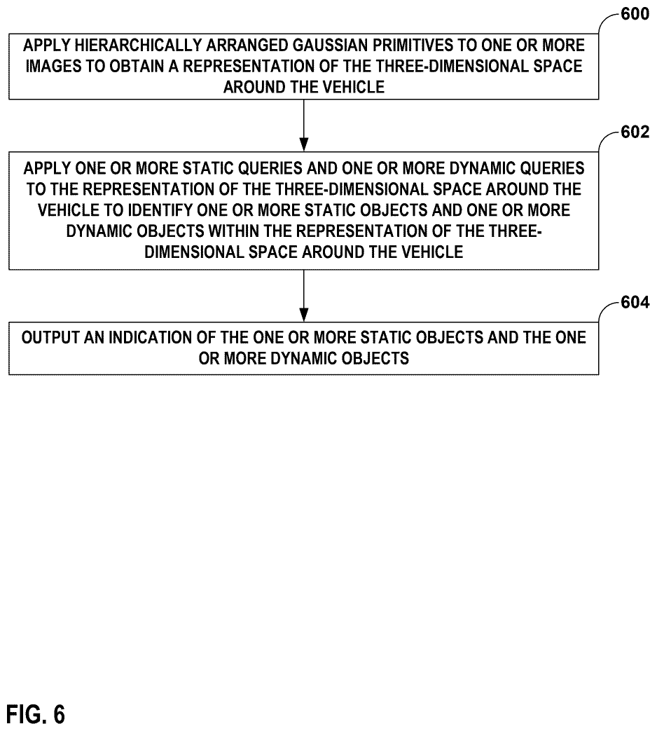

FIG. 6 is a flowchart illustrating example operation of an autonomous driving controller 120 shown in the example of FIG. 1 in performing the techniques described in this disclosure. Autonomous driving controller 120 may first apply hierarchically arranged gaussian primitives to one or more images to obtain a representation of the three-dimensional (3D) space around the vehicle 100 (600). The autonomous driving controller 120 may next apply one or more static queries and one or more dynamic queries to the representation of the 3D space around the vehicle 100 to identify one or more static objects and one or more dynamic objects within the representation of the 3D space around the vehicle 100 (602). The autonomous driving controller 120 may then output an indication of the one or more static objects and the one or more dynamic objects (604).

Various examples of the techniques of this disclosure are summarized in the following clauses:

Clause 1. A method of processing image data, the method comprising: obtaining, from a multi-camera system of a vehicle, one or more images of a three-dimensional space around the vehicle; applying hierarchically arranged Gaussian primitives to the one or more images to obtain a representation of the three-dimensional space around the vehicle; applying one or more static queries and one or more dynamic queries to the representation of the three-dimensional space around the vehicle to identify one or more static objects and one or more dynamic objects within the representation of the three-dimensional space around the vehicle; and outputting an indication of the one or more static objects and the one or more dynamic objects.

Clause 2. The method of clause 1, wherein applying the hierarchically arranged Gaussian primitives includes applying a coarse Gaussian primitives to obtain a coarse representation of the three-dimensional space around the vehicle followed by applying one or more fine Gaussian primitives.

Clause 3. The method of any of clauses 1 and 2, further comprising performing cross-attention between the one or more static queries and the one or more dynamic queries.

Clause 4. The method of any of clauses 1-3, wherein the one or more dynamic queries are defined as a query or a dynamic key-value pair, and wherein the one or more static queries are defined as the query or a static key-value pair.

Clause 5. The method of any of clauses 1-4, wherein the one or more static queries and the one or more dynamic queries are combined to obtain one or more combined queries, and wherein the method further comprises applying self-attention to the one or more combined queries.

Clause 6. The method of any of clauses 1-5, wherein applying the one or more static queries and the one or more dynamic queries includes learning, for each of the one or more dynamic queries, a velocity of each of the one or more dynamic objects, and wherein outputting the one or more static objects and the one or more dynamic objects includes outputting the velocity of each of the one or more dynamic objects.

Clause 7. The method of clause 6, wherein learning the velocity of each of the one or more dynamic objects includes approximating the velocity for each of the one or more dynamic objects using an exposure time of the multi-camera system.

Clause 8. The method of any of clauses 1-7, further comprising: predicting, for the one or more dynamic objects, a bounding box and a corresponding class score from each of the one or more dynamic queries; and applying bounding box supervisors to the bounding box to obtain a supervised bounding box representing a respective occupancy of each of the one or more dynamic objects occupancy within the representation of the three-dimensional space around the vehicle.

Clause 9. The method of any of clauses 1-8, wherein applying the hierarchically arranged Gaussian primitives includes: performing feature sampling for each point decoding layer; performing one or more of self-attention and cross-attention between each of the point decoding layers; and applying a feed forward network in each of the point decoding layers to identify the one or more static objects and the one or more dynamic objects, wherein the dynamic objects are identified via a bounding box.

Clause 10. The method of any of clauses 1-9, further comprising performing Gaussian splatting rendering to obtain a depth map and a semantic map, the semantic image map including labels identifying the one or more static objects and the one or more dynamic objects.

Clause 11. The method of any of clauses 1-10, further comprising supervising the one or more static objects and the one or more dynamic objects using a three dimensional occupancy ground truth to adapt the an application of the hierarchically arranged Gaussian primitives.

Clause 12. The method of any of clauses 1-11, further comprising applying an image encoder to the one or more images to obtain multi-scale features, wherein applying the hierarchically arranged Gaussian primitives includes applying the hierarchically arranged Gaussian primitives to the multi-scale features.

Clause 13. The method of any of clauses 1-12, further comprising: extracting a subset of points from a ground truth three-dimensional point cloud that represent the one or more dynamic objects to provide point-level supervision to the one or more dynamic queries in terms of both three dimensional positions and semantic classes.

Clause 14. The method of clause 13, further comprising: increasing a density of points in the subset of points from the ground truth three-dimensional point cloud to obtain densified points; and supervising the densified points using the subset of points from the ground truth three-dimensional point cloud.

Clause 15. A device for processing image data, the device comprising: a memory for storing one or more images of a three-dimensional space around a vehicle; and a processing system comprising one or more processors implemented in circuitry, the processing system being configured to: apply hierarchically arranged Gaussian primitives to the one or more images to obtain a representation of the three-dimensional space around the vehicle; apply one or more static queries and one or more dynamic queries to the representation of the three-dimensional space around the vehicle to identify one or more static objects and one or more dynamic objects within the representation of the three-dimensional space around the vehicle; and output an indication of the one or more static objects and the one or more dynamic objects.

Clause 16. The device of clause 15, wherein the processing system is configured to apply a coarse Gaussian primitives to obtain a coarse representation of the three-dimensional space around the vehicle followed by applying one or more fine Gaussian primitives.

Clause 17. The device of any of clauses 15 and 16, wherein the processing system is further configured to perform cross-attention between the one or more static queries and the one or more dynamic queries.

Clause 18. The device of any of clauses 15-17, wherein the one or more dynamic queries are defined as a query or a dynamic key-value pair, and wherein the one or more static queries are defined as the query or a static key-value pair.

Clause 19. The device of any of clauses 15-18, wherein the one or more static queries and the one or more dynamic queries are combined to obtain one or more combined queries, and wherein the processing system is further configured to apply self-attention to the one or more combined queries.

Clause 20. The device of any of clauses 15-19, wherein the processing system is configured to: learn, for each of the one or more dynamic queries, a velocity of each of the one or more dynamic objects, and output the velocity of each of the one or more dynamic objects.

Clause 21. The device of clause 20, wherein the processing system is configured to approximate the velocity for each of the one or more dynamic objects using an exposure time of the multi-camera system.

Clause 22. The device of any of clauses 15-21, wherein the processing system is further configured to: predict, for the one or more dynamic objects, a bounding box and a corresponding class score from each of the one or more dynamic queries; and apply bounding box supervisors to the bounding box to obtain a supervised bounding box representing a respective occupancy of each of the one or more dynamic objects within the representation of the three-dimensional space around the vehicle.

Clause 23. The device of any of clauses 15-22, wherein the processing system is configured to: perform feature sampling for each point decoding layer; perform one or more of self-attention and cross-attention between each of the point decoding layers; and apply a feed forward network in each of the point decoding layers to identify the one or more static objects and the one or more dynamic objects, wherein the dynamic objects are identified via a bounding box.

Clause 24. The device of any of clauses 15-23, wherein the processing system is further configured to perform Gaussian splatting rendering to obtain a depth map and a semantic map, the semantic map including labels identifying the one or more static objects and the one or more dynamic objects.

Clause 25. The device of any of clauses 15-24, wherein the processing system is further configured to supervise the one or more static objects and the one or more dynamic objects using a three dimensional occupancy ground truth to adapt an application of the hierarchically arranged Gaussian primitives.

Clause 26. The device of any of clauses 15-25, wherein the processing system is further configured to apply an image encoder to the one or more images to obtain multi-scale features, wherein the processing system is configured to apply the hierarchically arranged Gaussian primitives to the multi-scale features.

Clause 27. The device of any of clauses 15-26, wherein the processing system is further configured to extract a subset of points from a ground truth three-dimensional point cloud that represent the one or more dynamic objects to provide point-level supervision to the one or more dynamic queries in terms of both three dimensional positions and semantic classes.

Clause 28. The device of clause 27, wherein the processing system is further configured to: increase a density of points in the subset of points from the ground truth three-dimensional point cloud to obtain densified points; and supervise the densified points using the subset of points from the ground truth three-dimensional point cloud.

Clause 29. A device for processing media data, the device comprising: means for obtaining, from a multi-camera system of a vehicle, one or more images of a three-dimensional space around the vehicle; means for applying hierarchically arranged Gaussian primitives to the one or more images to obtain a representation of the three-dimensional space around the vehicle; means for applying one or more static queries and one or more dynamic queries to the representation of the three-dimensional space around the vehicle to identify one or more static objects and one or more dynamic objects within the representation of the three-dimensional space around the vehicle; and means for outputting an indication of the one or more static objects and the one or more dynamic objects.

Clause 30. A computer program product that includes non-transitory computer-readable storage media storing instructions that, when executed, causes processing circuitry to: apply hierarchically arranged Gaussian primitives to one or more images and obtain a representation of a three-dimensional space around a vehicle; apply one or more static queries and one or more dynamic queries to the representation of the three-dimensional space around the vehicle to identify one or more static objects and one or more dynamic objects within the representation of the three-dimensional space around the vehicle; and output an indication of the one or more static objects and the one or more dynamic objects.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method of processing image data, the method comprising:
obtaining, from a multi-camera system of a vehicle, one or more images of a three-dimensional space around the vehicle;
applying hierarchically arranged Gaussian primitives to the one or more images to obtain a representation of the three-dimensional space around the vehicle;
applying one or more static queries and one or more dynamic queries to the representation of the three-dimensional space around the vehicle to identify one or more static objects and one or more dynamic objects within the representation of the three-dimensional space around the vehicle; and
outputting an indication of the one or more static objects and the one or more dynamic objects.

2. The method of claim 1, wherein applying the hierarchically arranged Gaussian primitives includes applying a coarse Gaussian primitives to obtain a coarse representation of the three-dimensional space around the vehicle followed by applying one or more fine Gaussian primitives.

3. The method of claim 1, further comprising performing cross-attention between the one or more static queries and the one or more dynamic queries.

4. The method of claim 1,
wherein the one or more dynamic queries are defined as a query or a dynamic key-value pair, and
wherein the one or more static queries are defined as the query or a static key-value pair.

5. The method of claim 1,
wherein the one or more static queries and the one or more dynamic queries are combined to obtain one or more combined queries, and
wherein the method further comprises applying self-attention to the one or more combined queries.

6. The method of claim 1,
wherein applying the one or more static queries and the one or more dynamic queries includes learning, for each of the one or more dynamic queries, a velocity of each of the one or more dynamic objects, and
wherein outputting the one or more static objects and the one or more dynamic objects includes outputting the velocity of each of the one or more dynamic objects.

7. The method of claim 6, wherein learning the velocity of each of the one or more dynamic objects includes approximating the velocity for each of the one or more dynamic objects using an exposure time of the multi-camera system.

8. The method of claim 1, further comprising
predicting, for the one or more dynamic objects, a bounding box and a corresponding class score from each of the one or more dynamic queries; and
applying bounding box supervisors to the bounding box to obtain a supervised bounding box representing a respective occupancy of each of the one or more dynamic objects within the representation of the three-dimensional space around the vehicle.

9. The method of claim 1, wherein applying the hierarchically arranged Gaussian primitives includes:
performing feature sampling for each point decoding layer;
performing one or more of self-attention and cross-attention between each of the point decoding layers; and
applying a feed forward network in each of the point decoding layers to identify the one or more static objects and the one or more dynamic objects, wherein the dynamic objects are identified via a bounding box.

10. The method of claim 1, further comprising performing Gaussian splatting rendering to obtain a depth map and a semantic map, the semantic map including labels identifying the one or more static objects and the one or more dynamic objects.

11. The method of claim 1, further comprising supervising the one or more static objects and the one or more dynamic objects using a three dimensional occupancy ground truth to adapt an application of the hierarchically arranged Gaussian primitives.

12. The method of claim 1, further comprising applying an image encoder to the one or more images to obtain multi-scale features,
wherein applying the hierarchically arranged Gaussian primitives includes applying the hierarchically arranged Gaussian primitives to the multi-scale features.

13. The method of claim 1, further comprising:
extracting a subset of points from a ground truth three-dimensional point cloud that represent the one or more dynamic objects to provide point-level supervision to the one or more dynamic queries in terms of both three dimensional positions and semantic classes.

14. The method of claim 13, further comprising:
increasing a density of points in the subset of points from the ground truth three-dimensional point cloud to obtain densified points; and
supervising the densified points using the subset of points from the ground truth three-dimensional point cloud.

15. A device for processing image data, the device comprising:
a memory for storing one or more images of a three-dimensional space around a vehicle; and
a processing system comprising one or more processors implemented in circuitry, the processing system being configured to:
apply hierarchically arranged Gaussian primitives to the one or more images to obtain a representation of the three-dimensional space around the vehicle;
apply one or more static queries and one or more dynamic queries to the representation of the three-dimensional space around the vehicle to identify one or more static objects and one or more dynamic objects within the representation of the three-dimensional space around the vehicle; and
output an indication of the one or more static objects and the one or more dynamic objects.

16. The device of claim 15, wherein the processing system is configured to apply a coarse Gaussian primitives to obtain a coarse representation of the three-dimensional space around the vehicle followed by applying one or more fine Gaussian primitives.

17. The device of claim 15, wherein the processing system is further configured to perform cross-attention between the one or more static queries and the one or more dynamic queries.

18. The device of claim 15,
wherein the one or more dynamic queries are defined as a query or a dynamic key-value pair, and
wherein the one or more static queries are defined as the query or a static key-value pair.

19. The device of claim 15,
wherein the one or more static queries and the one or more dynamic queries are combined to obtain one or more combined queries, and
wherein the processing system is further configured to apply self-attention to the one or more combined queries.

20. A computer program product that includes non-transitory computer-readable storage media storing instructions that, when executed, causes processing circuitry to:
apply hierarchically arranged Gaussian primitives to one or more images and obtain a representation of a three-dimensional space around a vehicle;
apply one or more static queries and one or more dynamic queries to the representation of the three-dimensional space around the vehicle to identify one or more static objects and one or more dynamic objects within the representation of the three-dimensional space around the vehicle; and
output an indication of the one or more static objects and the one or more dynamic objects.
